(19) United States
(12) Patent Application Publication
(10) Pub. No.: US 2017/0280054 A1
(43) Pub. Date: Sep. 28, 2017

(54) METHOD AND ELECTRONIC DEVICE FOR PANORAMIC LIVE BROADCAST

(71) Applicants: Le Holdings (Beijing) Co., Ltd., Beijing (CN); LE SHI INTERNET INFORMATION & TECHNOLOGY CORP., BEIJING, Beijing (CN)

(72) Inventor: Liang LI, Beijing (CN)

(21) Appl. No.: 15/245,976

(22) Filed: Aug. 24, 2016

Related U.S. Application Data
(63) Continuation of application No. PCT/CN2016/089347, filed on Jul. 8, 2016.

(30) Foreign Application Priority Data
Mar. 22, 2016 (CN) 201610166645.1

(51) Int. Cl. H04N 5/232; H04N 5/247; H04N 21/2187; H04N 21/2343; H04N 21/4223; H04N 21/234; H04N 21/44; H04N 21/4402; H04N 5/265; H04N 21/218

(52) U.S. Cl. CPC H04N 5/23238; H04N 5/265; H04N 5/247; H04N 21/2187; H04N 21/21805; H04N 21/4223; H04N 21/23418; H04N 21/44008; H04N 21/4402; H04N 21/2343; G06F 3/04845

(57) ABSTRACT

A method for panoramic live broadcast is disclosed. The method includes: continuously receiving collected pictures of live broadcast cameras at different viewpoints; combining the collected pictures of the live broadcast cameras at different viewpoints in each frame into a panoramic picture; receiving terminal posture change data; performing analysis to obtain a terminal change angle according to the terminal posture change data; performing calculation to obtain a new live picture viewpoint according to a viewpoint of a current live picture and the terminal change angle; and selecting a picture corresponding to the new live picture viewpoint from the panoramic picture as a new live picture.

### CROSS REFERENCE TO RELATED APPLICATIONS

The present disclosure is a continuation application of PCT International patent application No. PCT/CN2016/089347, filed on Jul. 8, 2016, which claims priority to Chinese Patent Application No. 201610166645.1, filed with the Chinese Patent Office on Mar. 22, 2016, both of which are herein incorporated by reference in their entireties.

### TECHNICAL FIELD

The present disclosure relates to the field of data processing and control technologies, and particularly, to a method and an electronic device for panoramic live broadcast.

### BACKGROUND

With the continuous development of network technologies, application of the network technologies is popularized to all aspects of social lives. Live programs, such as soccer games and galas, that once can only be viewed by using televisions now can be viewed by using networks, which facilitates lives of people.

With regard to current live programs, pictures are collected by using live broadcast cameras at different viewpoints on site, then a live broadcast server is in overall charge of switching between pictures, and further, the pictures are sent to terminals to be directly viewed.

### SUMMARY

An embodiment of the present disclosure provides a method for panoramic live broadcast. The method includes: at an electronic device, continuously receiving collected pictures of live broadcast cameras at different viewpoints; combining the collected pictures of the live broadcast cameras at different viewpoints in each frame into a panoramic picture; receiving terminal posture change data; performing analysis to obtain a terminal change angle according to the terminal posture change data; performing calculation to obtain a new live picture viewpoint according to a viewpoint of a current live picture and the terminal change angle; and selecting a picture corresponding to the new live picture viewpoint from the panoramic picture as a new live picture.

Another embodiment of the present disclosure provides an electronic device. The electronic device includes: at least one processor and a memory. The memory is communicably connected with the at least one processor for storing instructions executable by the at least one processor. Wherein execution of the instructions by the at least one processor causes the at least one processor to:

continuously receive collected pictures of live broadcast cameras at different viewpoints;

combine the collected pictures of the live broadcast cameras at different viewpoints in each frame into a panoramic picture;

receive terminal posture change data;

perform analysis to obtain a terminal change angle according to the terminal posture change data;

perform calculation to obtain a new live picture viewpoint according to a viewpoint of a current live picture and the terminal change angle; and

select a picture corresponding to the new live picture viewpoint from the panoramic picture as a new live picture.

Still another embodiment of the present disclosure provides a non-transitory computer-readable storage medium. The non-transitory computer-readable storage medium stores executable instructions. When the executable instructions is executed by an electronic device, causes the electronic device to:

continuously receive collected pictures of live broadcast cameras at different viewpoints;

combine the collected pictures of the live broadcast cameras at different viewpoints in each frame into a panoramic picture;

receive terminal posture change data;

perform analysis to obtain a terminal change angle according to the terminal posture change data;

perform calculation to obtain a new live picture viewpoint according to a viewpoint of a current live picture and the terminal change angle; and

select a picture corresponding to the new live picture viewpoint from the panoramic picture as a new live picture.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of an embodiment of a method for panoramic live broadcast according to the present application;

FIG. 2 is a flowchart of another embodiment of a method for panoramic live broadcast according to the present application;

FIG. 3 is a schematic structural diagram of an embodiment of an apparatus for panoramic live broadcast according to the present application;

FIG. 4 is a schematic structural diagram of an embodiment of a server according to the present application.

### DETAILED DESCRIPTION

In order to make the objectives, technical solutions, and advantages of the present disclosure more comprehensible, the present disclosure is described in further detail below with reference to the embodiments and the accompanying drawings.

It should be noted that the expressions, “first” and “second”, used in the embodiments of the present disclosure both aim at distinguishing two different entities or different parameters having the same name. In view of this, “first” and “second” are merely used for convenience of expression and should not be interpreted as limitations to the embodiments of present disclosure, which is not described in the following embodiments one by one.

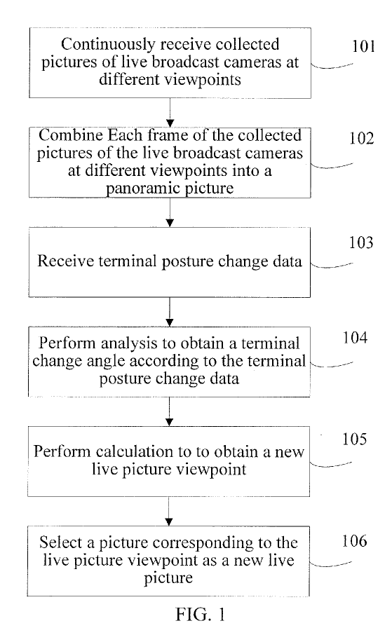

FIG. 1 is a flowchart of an embodiment of a method for panoramic live broadcast according to the present application.

The method is applied to a mobile terminal and includes the following steps:

In Step 101: Continuously receive collected pictures of live broadcast cameras at different viewpoints.

In some exemplary embodiments, the live broadcast camera is a camera positioned at a live broadcast site and configured to collect an on-site picture. Herein, the live broadcast cameras at different viewpoints refer to cameras positioned at different locations of the live broadcast site and configured to collect on-site pictures from different viewpoints, where a number thereof could be set according to requirements. The collected pictures of the live broadcast cameras at different viewpoints are continuously connected and are sent from the live broadcast site to a live broadcast server, after receiving the collected pictures of the live broadcast cameras at different viewpoints, the live broadcast server further sends the collected pictures to different mobile terminals that request for the on-site live broadcast service, and herein, the collected pictures of the live broadcast cameras at different viewpoints that are continuously received by the mobile terminals are the collected pictures of the live broadcast cameras at different viewpoints that are forwarded by the live broadcast server.

In Step 102: Combine each frame of the collected pictures of the live broadcast cameras at different viewpoints in into a panoramic picture.

In the process of continuously receiving collected pictures of live broadcast cameras at different viewpoints, the collected pictures of live broadcast cameras at different viewpoints in a frame corresponding to a same time point are correspondingly combined into a frame of panoramic picture. A panoramic picture combination manner in the prior art may be used as the combination manner of the panoramic picture and includes overlapping of the collected pictures of the respective live broadcast cameras at edge portions, corresponding pixel fusion processing, and the like.

In Step 103: Receive terminal posture change data.

The terminal posture change data herein refers to data generated when the posture of the terminal changes, that is, when terminal posture change data is received, it indicates that the posture of the terminal changes. The terminal posture change data may be collected by using a sensor, such as a gravity sensor or a gyroscope, capable of sensing acceleration of the terminal, and when sensor data changes, it indicates that the posture of the terminal changes.

In Step 104: Perform analysis to obtain a terminal change angle according to the terminal posture change data.

In some exemplary embodiments, assuming that the terminal is a smart phone and the current posture thereof is that a plane where a screen is located is vertical to the ground and the screen is transversely placed, when sensor data collected by a gyroscope serves as the terminal posture change data, a current posture change manner and degree of the terminal can be learned by analyzing the sensor data, for example, when the current terminal rotates clockwise, as being viewed from the top, with a central axis of the gyroscope as an axis, a current terminal rotation angle can be calculated by using the data collected by using the sensor data, that is, a terminal change angle is calculated. For example, by means of calculation, the smart phone rotates by 15° clockwise (as being view from the top).

In Step 105: Perform calculation to obtain a new live picture viewpoint according to a viewpoint of a current live picture and the terminal change angle.

Because collected pictures at a live broadcast site are preprocessed into a panoramic picture, and the panoramic picture corresponds to an angle of 360°, calculation can be performed according to the terminal change angle obtained by calculation and the viewpoint of the current live picture to obtain a new live picture viewpoint, for example, if a current live picture viewpoint is a picture corresponding to clockwise rotation of 45° around a preset reference 00 line, and a terminal change angle is clockwise rotation of 15°, the live picture viewpoint is clockwise rotation of 60° around a preset reference 0° line.

In Step 106: Select a picture corresponding to the new live picture viewpoint from the panoramic picture as a new live picture.

Herein, the panoramic picture is a 360° picture obtained by preprocessing, the new live picture viewpoint obtained by calculation may be any viewpoint, and a new live picture corresponding to the new live picture viewpoint is a full picture that uses the new live picture viewpoint as a center, that is obtained as being projected to the panoramic picture, and that can correspond to the size of a terminal screen, that is, the size of the new live picture is the size of a picture corresponding to an angle that can be collected by a live broadcast camera. A selection manner may be making a selection from the panoramic picture according to an angle that can be collected by a live broadcast camera. Therefore, it could be known that the live picture may just be a picture collected by a live broadcast camera or may be an intersection between pictures collected by two or more live broadcast cameras.

In view of the foregoing embodiment, in the method provided by the embodiments of the present disclosure, by means of continuously receiving collected pictures of live broadcast cameras at different viewpoints and combining pictures in each frame into a panoramic picture, when terminal posture change data is received and a terminal change angle is correspondingly calculated, calculation can be performed according to a viewpoint of a current live picture and the terminal change angle to obtain a new live picture viewpoint and select a corresponding picture from the panoramic picture as a new live picture. In this way, a user can obtain a corresponding viewing viewpoint by changing a terminal posture, in an aspect, it is not needed to be limited by a live broadcast viewpoint provided by a live broadcast server, and in another aspect, since any view point can be selected in such an adjusting manner, it is not needed to be limited by a fixed view point of a live broadcast camera, so that better user experience is provided.

In addition, the panoramic picture may be an annular 360° picture and may also be a hemispherical picture obtained according to collected pictures of live broadcast cameras at different pitching angles. At this time, the angles include three axes, namely, x, y, and z axes, and a calculation manner is similar to the foregoing exemplified manner, but needs further correction and more calculation steps, and is not further described.

In some exemplary embodiments, the live broadcast cameras at different viewpoints include a main live broadcast camera.

After step 101 of receiving collected pictures of live broadcast cameras at different viewpoints, the method further includes: in an initial state, using a collected picture of the main live broadcast camera as an initial live picture.

The initial live picture in the initial state is set to be a collected picture of the main live broadcast camera, so as to guide viewing of a user and provide better viewing experience for the user.

Further, after step 103 of receiving terminal posture change data, the method may further includes the following step:

determining whether the terminal posture change data within a preset time interval is between preset posture change data thresholds, where the preset posture change data thresholds are associated with an instruction of returning to the collected picture of the main live broadcast camera, and the preset time interval may be a value that is set by default or a value that is customized by a user, for example, 2 to 5 seconds; and

switching from a current live picture to the collected picture of the main live broadcast camera if the terminal posture change data within the preset time interval is between the preset posture change data thresholds.

The preset posture change data thresholds are thresholds between which the terminal posture change data, which is generated corresponding to the posture change that needs to be aroused externally by the user according to a specified action, needs to be located, and if the terminal posture change data is between the thresholds, it is determined that the posture change aroused externally by the user meets a specified action, so that a corresponding instruction is generated. Herein, the specified action may be set to be, for example, horizontally or vertically shaking for one or more times, if with occurrence of the specified action, corresponding terminal posture change data is generated within the preset time interval, and the terminal posture change data is between the preset posture change data thresholds, it is determined that the specified action occurs, a corresponding instruction is triggered, and in this embodiment, an instruction of returning to the collected picture of the main live broadcast camera is triggered, so as to return to the collected picture of the main live broadcast camera.

A status where a viewpoint is not suitable for viewing may occur because of continuous viewpoint switching by a user, and from the foregoing embodiment, it could be known that with the occurrence of the specified action, the live picture may be switched back to the collected picture of the main live broadcast camera, so as to enable the user to conveniently return to the viewpoint that is more suitable for viewing to continue the viewing.

In addition, by means of the foregoing manner of returning to the collected picture of the main live broadcast camera, an initial posture of a user terminal may be adjusted in this manner, for example, at first, a user views a live program by using a lying posture, and the posture of the terminal is also correspondingly a posture where the screen is in parallel to the ground, and when the user needs to sit up, at this time, the action may be misinterpreted as that the user needs to adjust angle, so that a viewpoint is switched, and at this time, the user only needs to switch the viewpoint back to the viewpoint of the main live broadcast camera by means of a specified action, so as to correct a collection base point of the sensor, thereby enabling the user to correspondingly adjust the viewpoint by shaking the terminal in a sitting state, so as to obtain a desired viewpoint thereof.

In some exemplary embodiments, step 104 of performing analysis to obtain a terminal change angle according to the terminal posture change data needs to be further specified to distinguish whether the terminal posture change data is a terminal angle change or a change occurred for turning to the collected picture of the main live broadcast camera. By distinguishing a change rate and direction of acceleration, it could be distinguished whether the terminal returns to the original place after rotating to a specific angle or reciprocates, that is, when the terminal posture change data is not between the preset posture change data thresholds, it is determined that the terminal change angle needs to be calculated according to the terminal posture change data, and the live broadcast viewpoint is correspondingly changed, and when the terminal posture change data is between the preset posture change data thresholds, the live picture is switched to the collected picture of the main live broadcast camera.

In some exemplary embodiments, after step 102 of combining the collected pictures of the live broadcast cameras at different viewpoints into a panoramic picture, the method may further includes:

receiving terminal touch gesture data, where the terminal touch gesture data is data generated on the terminal because of a touch gesture;

determining whether the terminal touch gesture data is between preset touch gesture data thresholds, where the preset touch gesture data thresholds are associated with an instruction of scaling the live picture, and the preset touch gesture data thresholds being associated with an instruction of scaling the live picture herein refers to when it is monitored that the terminal touch gesture data is between preset touch gesture data thresholds, determining that an instruct of scaling a live picture is currently generated;

if the terminal touch gesture data is between the preset touch gesture data thresholds, calculation is performed to obtain a scaling ratio and a trigger location of the terminal touch gesture data according to the terminal touch gesture data. The terminal touch gesture data can be obtained by: for example, if a terminal touch gesture is tapping the screen with two fingers and sliding the two fingers away from each other, determining that an instruction of scaling up the live picture is received, and according to a length by which the fingers slide, performing calculation to obtain a corresponding scaling-up ratio, and on the contrary, if a terminal touch gesture is tapping the screen with two fingers and sliding the two fingers toward each other, determining that an instruction of scaling down the live picture is received, according to a length by which the fingers slide, performing calculation to obtain a corresponding scaling-down ratio;

scaling the current live picture with the trigger location as a center according to the scaling ratio.

By means of the foregoing embodiment, a user can perform an operation on the live picture in real time according to a requirement thereof, so as to obtain a desired scaling ratio thereof, and also can obtain a close-up picture of a person or a scene in which the user is interested by using this function.

In some exemplary embodiments, before step 103 of receiving terminal posture change data, the method may further includes:

receiving an angle multiple change instruction, where the angle multiple change instruction may be an instruction sent when a preset angle multiple icon (for example, 0.5 times, 2 times, or 4 times) in the screen is tapped or may be an angle multiple change instruction issued by means of the touch gesture, for example, a single-point upward slide is to increase the multiple, and a single-point downward slide is to decrease the multiple;

performing analysis to obtain an angle change multiple according to the terminal multiple change instruction, where if the terminal multiple change instruction is sent when an angle multiple icon is tapped, a multiple corresponding to the corresponding icon is an angle change multiple, and if adjustment is performed in a single-point sliding manner, the angle change multiple can be calculated according to a sliding length;

Step of performing analysis to obtain a terminal change angle according to the terminal posture change data includes:

performing analysis to obtain an original change angle according to the terminal posture change data; and

performing calculation to obtain a terminal change angle, based on the angle change multiple and the original change angle.

By means of the foregoing embodiment, a user is enabled to adjust an angle multiple change thereof according to a requirements, that is, different angle multiple changes enable a viewpoint change corresponding to an angle by which the user rotates the terminal to be a change of a multiple times a rotation angle, so as to adapt to operation habits of different users.

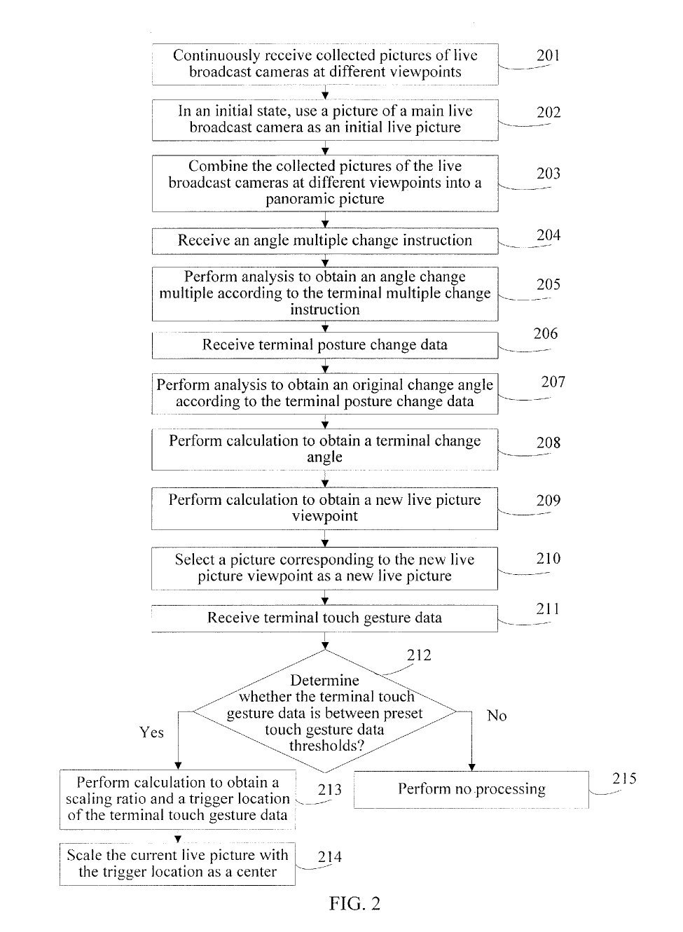

FIG. 2 is a flowchart of another embodiment of a method for panoramic live broadcast according to the present application. The method includes the following steps.

In Step 201: Continuously receive collected pictures of live broadcast cameras at different viewpoints.

In Step 202: In an initial state, use a collected picture of a main live broadcast camera as an initial live picture.

In Step 203: Combine the collected pictures of the live broadcast cameras at different viewpoints in each frame into a panoramic picture.

In Step 204: Receive an angle multiple change instruction.

In Step 205: Perform analysis to obtain an angle change multiple according to the terminal multiple change instruction.

In Step 206: Receive terminal posture change data.

In Step 207: Perform analysis to obtain an original change angle according to the terminal posture change data.

In Step 208: Perform calculation to obtain a terminal change angle, based on the angle change multiple and the original change angle.

In Step 209: Perform calculation to obtain a new live picture viewpoint according to a viewpoint of a current live picture and the terminal change angle.

In Step 210: Select a picture corresponding to the new live picture viewpoint from the panoramic picture as a new live picture.

In Step 211: Receive terminal touch gesture data.

In Step 212: Determine whether the terminal touch gesture data is between preset touch gesture data thresholds, where the preset touch gesture data thresholds are associated with an instruction of scaling the live picture.

In Step 213: Perform calculation to obtain a scaling ratio and a trigger location of the terminal touch gesture data according to the terminal touch gesture data if the terminal touch gesture data is between the preset touch gesture data thresholds.

In Step 214: Scale the current live picture with the trigger location as a center according to the scaling ratio.

In Step 215: Perform no processing if the terminal touch gesture data is between the preset touch gesture data thresholds.

In view of the foregoing embodiment, in the method provided by the embodiments of the present disclosure, by means of continuously receiving collected pictures of live broadcast cameras at different viewpoints and combining pictures in each frame into a panoramic picture, when terminal posture change data is received and a terminal change angle is correspondingly calculated, calculation can be performed according to a viewpoint of a current live picture and the terminal change angle to obtain a new live picture viewpoint and select a corresponding picture from the panoramic picture as a new live picture. In this way, a user can obtain a corresponding viewing viewpoint by changing a terminal posture, in an aspect, it is not needed to be limited by a live broadcast viewpoint provided by a live broadcast server, and in another aspect, since any view point can be selected in such an adjusting manner, it is not needed to be limited by a fixed view point of a live broadcast camera, so that better user experience is provided.

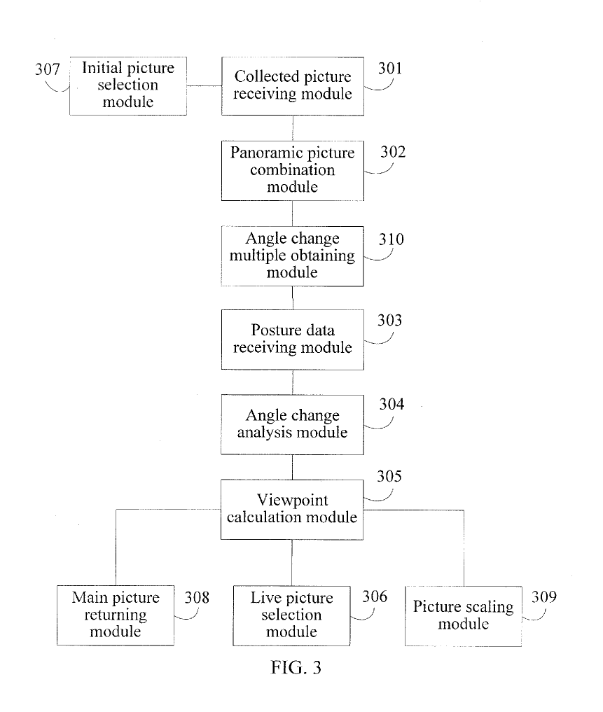

FIG. 3 is a schematic structural diagram of an embodiment of an apparatus 300 for panoramic live broadcast according to the present application. The apparatus 300 includes: a collected picture receiving module 301, a panoramic picture combination module 302, a posture data receiving module 303, a angle change analysis module 304, a viewpoint calculation module 305, and a live picture selection module 306.

The collected picture receiving module 301 is configured to continuously receive collected pictures of live broadcast cameras at different viewpoints.

In some exemplary embodiments, the live broadcast camera is a camera positioned at a live broadcast site and configured to collect an on-site picture; herein, the live broadcast cameras at different viewpoints refer to cameras positioned at different locations of the live broadcast site and configured to collect on-site pictures from different viewpoints, where a number of cameras could be set according to requirements; the collected pictures of the live broadcast cameras at different viewpoints are continuously connected and are sent from the live broadcast site to a live broadcast server, after receiving the collected pictures of the live broadcast cameras at different viewpoints, the live broadcast server further sends the collected pictures to different mobile terminals that request for the on-site live broadcast service, and herein, the collected pictures of the live broadcast cameras at different viewpoints that are continuously received by the mobile terminals are the collected pictures of the live broadcast cameras at different viewpoints that are forwarded by the live broadcast server.

The panoramic picture combination module 302 is configured to combine the collected pictures of the live broadcast cameras at different viewpoints in each frame into a panoramic picture.

In some exemplary embodiments, in the process of continuously receiving collected pictures of live broadcast cameras at different viewpoints, the collected pictures of live broadcast cameras at different viewpoints in a frame corresponding to a same time point are correspondingly combined into a frame of panoramic picture. A panoramic picture combination manner in the prior art may be used as the combination manner of the panoramic picture and includes overlapping of the collected pictures of the respective live broadcast cameras at edge portions, corresponding pixel fusion processing, and the like;

The posture data receiving module 303 is configured to receive terminal posture change data.

In some exemplary embodiments, the terminal posture change data therein refers to data generated when the posture of the terminal changes, that is, when terminal posture change data is received, it indicates that the posture of the terminal changes; and the terminal posture change data may be collected by using a sensor, such as a gravity sensor or a gyroscope, capable of sensing acceleration of the terminal, and when sensor data changes, it indicates that the posture of the terminal changes.

The angle change analysis module 304 is configured to perform analysis to obtain a terminal change angle according to the terminal posture change data.

For example, assuming that the terminal is a smart phone and the current posture thereof is that a plane where a screen is located is vertical to the ground and the screen is transversely placed, when sensor data collected by a gyroscope serves as the terminal posture change data, a current posture change manner and degree of the terminal can be learned by analyzing the sensor data, for example, when the current terminal rotates clockwise, as being viewed from the top, with a central axis of the gyroscope as an axis, a current terminal rotation angle can be calculated by using the data collected by using the sensor data, that is, a terminal change angle is calculated; and for example, by means of calculation, the smart phone rotates by 15° clockwise (as being view from the top).

The viewpoint calculation module 305 is configured to perform calculation to obtain a new live picture viewpoint according to a viewpoint of a current live picture and the terminal change angle.

Because collected pictures at a live broadcast site are preprocessed into a panoramic picture, and the panoramic picture corresponds to an angle of 360°, calculation can be performed according to the terminal change angle obtained by calculation and the viewpoint of the current live picture to obtain a new live picture viewpoint, for example, if a current live picture viewpoint is a picture corresponding to clockwise rotation of 45° around a preset reference 0° line, and a terminal change angle is clockwise rotation of 15°, the live picture viewpoint is clockwise rotation of 60° around a preset reference 0° line.

The live picture selection module 306 is configured to select a picture corresponding to the new live picture viewpoint from the panoramic picture as a new live picture.

The panoramic picture is a 360° picture obtained by preprocessing, the new live picture viewpoint obtained by calculation may be any viewpoint, and a new live picture corresponding to the new live picture viewpoint is a full picture that uses the new live picture viewpoint as a center, that is obtained as being projected to the panoramic picture, and that can correspond to the size of a terminal screen, that is, the size of the new live picture is the size of a picture corresponding to an angle that can be collected by a live broadcast camera; a selection manner may be making a selection from the panoramic picture according to an angle that can be collected by a live broadcast camera; and therefore, it could be known that the live picture may just be a picture collected by a live broadcast camera or may be an intersection between pictures collected by two or more live broadcast cameras.

In view of the foregoing embodiment, in the apparatus 300 provided by the embodiments of the present disclosure, by means of continuously receiving collected pictures of live broadcast cameras at different viewpoints and combining pictures in each frame into a panoramic picture, when terminal posture change data is received and a terminal change angle is correspondingly calculated, calculation can be performed according to a viewpoint of a current live picture and the terminal change angle to obtain a new live picture viewpoint and select a corresponding picture from the panoramic picture as a new live picture. In this way, a user can obtain a corresponding viewing viewpoint by changing a terminal posture, in an aspect, it is not needed to be limited by a live broadcast viewpoint provided by a live broadcast server, and in another aspect, since any view point can be selected in such an adjusting manner, it is not needed to be limited by a fixed view point of a live broadcast camera, so that better user experience is provided.

In addition, the panoramic picture may be an annular 360° picture and may also be a hemispherical picture obtained according to collected pictures of live broadcast cameras at different pitching angles. At this time, the angles include three axes, namely, x, y, and z axes, and a calculation manner is similar to the foregoing exemplified manner, but needs further correction and more calculation steps, and is not further described.

In some exemplary embodiments, the live broadcast cameras at different viewpoints include a main live broadcast camera. The apparatus 300 for panoramic live broadcast further includes: an initial picture selection module 307 configured to in an initial state, use a collected picture of the main live broadcast camera as an initial live picture.

The initial live picture in the initial state is set to be a collected picture of the main live broadcast camera, so as to guide viewing of a user and provide better viewing experience for the user.

In some exemplary embodiments, the apparatus 300 for panoramic live broadcast further includes a main picture returning module 308. The main picture returning module 308 is configured to:

determine whether the terminal posture change data within a preset time interval is between preset posture change data thresholds, where the preset posture change data thresholds are associated with an instruction of returning to the collected picture of the main live broadcast camera, and the preset time interval may be a value that is set by default or a value that is customized by a user, for example, 2 to 5 seconds; and

switch from a current live picture to the collected picture of the main live broadcast camera if the terminal posture change data within the preset time interval is between the preset posture change data thresholds.

The preset posture change data thresholds are thresholds between which the terminal posture change data, which is generated corresponding to the posture change that needs to be aroused externally by the user according to a specified action, needs to be located, and if the terminal posture change data is between the thresholds, it is determined that the posture change aroused externally by the user meets a specified action, so that a corresponding instruction is generated. Herein, the specified action may be set to be, for example, horizontally or vertically shaking for one or more times, if with occurrence of the specified action, corresponding terminal posture change data is generated within the preset time interval, and the terminal posture change data is between the preset posture change data thresholds, it is determined that the specified action occurs, a corresponding instruction is triggered, and in this embodiment, an instruction of returning to the collected picture of the main live broadcast camera is triggered, so as to return to the collected picture of the main live broadcast camera.

A status where a viewpoint is not suitable for viewing may occur because of continuous viewpoint switching by a user, and from the foregoing embodiment, it could be known that with the occurrence of the specified action, the live picture may be switched back to the collected picture of the main live broadcast camera, so as to enable the user to conveniently return to the viewpoint that is more suitable for viewing to continue the viewing.

In addition, by means of the foregoing manner of returning to the collected picture of the main live broadcast camera, an initial posture of a user terminal may be adjusted in this manner, for example, at first, a user views a live program by using a lying posture, and the posture of the terminal is also correspondingly a posture where the screen is in parallel to the ground, and when the user needs to sit up, at this time, the action may be misinterpreted as that the user needs to adjust angle, so that a viewpoint is switched, and at this time, the user only needs to switch the viewpoint back to the viewpoint of the main live broadcast camera by means of a specified action, so as to correct a collection base point of the sensor, thereby enabling the user to correspondingly adjust the viewpoint by shaking the terminal in a sitting state, so as to obtain a desired viewpoint thereof.

In some exemplary embodiments, perform analysis to obtain a terminal change angle according to the terminal posture change data needs to be further specified to distinguish whether the terminal posture change data is a terminal angle change or a change occurred for turning to the collected picture of the main live broadcast camera. By distinguishing a change rate and direction of acceleration, it could be distinguished whether the terminal returns to the original place after rotating to a specific angle or reciprocates, that is, when the terminal posture change data is not between the preset posture change data thresholds, it is determined that the terminal change angle needs to be calculated according to the terminal posture change data, and the live broadcast viewpoint is correspondingly changed, and when the terminal posture change data is between the preset posture change data thresholds, the live picture is switched to the collected picture of the main live broadcast camera.

In some exemplary embodiments, the apparatus 300 for panoramic live broadcast further includes a picture scaling module 309. The is picture scaling module 309 is configured to:

receive terminal touch gesture data, where the terminal touch gesture data is data generated on the terminal because of a touch gesture;

determine whether the terminal touch gesture data is between preset touch gesture data thresholds, where the preset touch gesture data thresholds are associated with an instruction of scaling the live picture, and the preset touch gesture data thresholds being associated with an instruction of scaling the live picture herein refers to when it is monitored that the terminal touch gesture data is between preset touch gesture data thresholds, determining that an instruct of scaling a live picture is currently generated;

perform calculation to obtain a scaling ratio and a trigger location of the terminal touch gesture data according to the terminal touch gesture data if the terminal touch gesture data is between the preset touch gesture data thresholds, where the terminal touch gesture data, is obtained by: for example, if a terminal touch gesture is tapping the screen with two fingers and sliding the two fingers away from each other, determining that an instruction of scaling up the live picture is received, and according to a length by which the fingers slide, performing calculation to obtain a corresponding scaling-up ratio, and on the contrary, if a terminal touch gesture is tapping the screen with two fingers and sliding the two fingers toward each other, determining that an instruction of scaling down the live picture is received, according to a length by which the fingers slide, performing calculation to obtain a corresponding scaling-down ratio; and

scale the current live picture with the trigger location as a center according to the scaling ratio.

By means of the foregoing embodiment, a user can perform an operation on the live picture in real time according to a requirement thereof, so as to obtain a desired scaling ratio thereof, and also can obtain a close-up picture of a person or a scene in which the user is interested by using this function.

In some exemplary embodiments, the apparatus 300 for panoramic live broadcast further includes an angle change multiple obtaining module 310. The angle change multiple obtaining module 310 is configured to:

receive an angle multiple change instruction, where the angle multiple change instruction may be an instruction sent when a preset angle multiple icon (for example, 0.5 times, 2 times, or 4 times) in the screen is tapped or may be an angle multiple change instruction issued by means of the touch gesture, for example, a single-point upward slide is to increase the multiple, and a single-point downward slide is to decrease the multiple; and

perform analysis to obtain an angle change multiple according to the terminal multiple change instruction, where if the terminal multiple change instruction is sent when an angle multiple icon is tapped, a multiple corresponding to the corresponding icon is an angle change multiple, and if adjustment is performed in a single-point sliding manner, the angle change multiple can be calculated according to a sliding length.

The angle change analysis module 304 is configured to:

perform analysis to obtain an original change angle according to the terminal posture change data; and

perform calculation to obtain a terminal change angle, based on the angle change multiple and the original change angle.

By means of the foregoing embodiments, a user is enabled to adjust an angle multiple change thereof according to a requirements, that is, different angle multiple changes enable a viewpoint change corresponding to an angle by which the user rotates the terminal to be a change of a multiple times a rotation angle, so as to adapt to operation habits of different users.

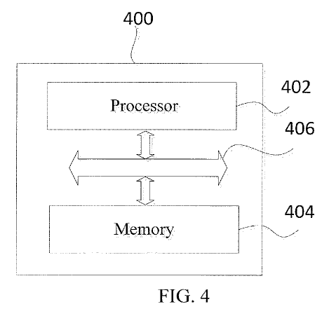

As shown in FIG. 4, an embodiment of a server 400 provided in the present disclosure includes: at least one processor 402, a memory 404, and a bus system 406. The at least one processor 402 and the memory 404 are connected to each other via the bus system 406, the memory 404 is configured to store program instructions, and the processor 402 is caused to execute the program instructions stored in the memory 404.

The memory 404 may be a non-transitory computed readable storage medium, which is configured to store computed executable program instructions. When the program instructions are executed by one or more central processors, for example, the at least one processor 402 may be caused to perform the steps in the above mentioned embodiments of the method, for example, steps 101 to 106 illustrated in FIG. 1, steps 201 to 215 illustrated in FIG. 2. The computed executable program instructions may also be stored and/or transmitted in any non-transitory computed readable storage medium, such that these program instructions are used by an instruction executing system, apparatus or device, or used in combination with the instruction executing system, apparatus or device. The instruction executing system, apparatus or device may be, for example, a computer-based system, a system including a processor or another system capable of acquiring program instructions from the instruction executing system, apparatus or device and executing the program instructions. For the purpose of this specification, the “non-transitory computed readable storage medium” may be any tangible medium including or storing computed executable program instructions. The computed executable program instructions may be used by the instruction executing system, apparatus or device, or used in combination with the executing system, apparatus or device. The non-transitory computed readable storage medium may include, but not limited to, a magnetic, optical and/or semiconductor memory. Examples of these memories include a magnetic disk, an optical disc based on CD, DVD and Blu-ray technology, and permanent solid memory (for example, a flash memory, a solid driver and the like).

In some embodiments, the apparatus 300 of FIG. 3, as mentioned above, may be a computed software program device, the modules 301-310 are computed software program modules, stored in the memory 404, and executed by the processor 402 to achieve the function of each module when in working.

It should be understood that in the embodiments of the present application, the processor 402 may be a central processing unit (CPU). The processor 402 may be a general processor, a digital signal processor (DSP), an application specific integrated circuit (ASIC), a field programmable gate array (FPGA) or another programmable logic device, a discrete gate or transistor logic device, or a discrete hardware component. The general processor may be a microprocessor or any customary processor or the like.

In addition to a data bus, the bus system 406 may further includes a power bus, a control bus, a state signal bus and the like. However, for clarity of description, various buses are all marked as the bus system 406.

In the embodiments of the present disclosure, the mobile terminal 400 is not limited to the components and configurations as illustrated in FIG. 4, but may further include other or additional components having a plurality of configurations.

During the implementation, various steps in the above method and various modules or units in the above apparatus may be implemented by means of an integrated logic circuit in the processor 402 or by means of software. The steps in the method and the modules or units in the apparatus disclosed in the embodiments of the present disclosure may be directly embodied as being implemented by a hardware processor, or implemented by a combination of hardware in the processor and other software modules. The software module may be located in a random memory, a flash memory, a read-only memory, a programmable read-only memory, an electrically erasable programmable memory, a register or the like storage medium commonly known in the art. The storage medium is located in the memory 404. The processor 402 reads the information stored in the memory 404 and performs the steps of the above method in combination with the hardware thereof. For brevity of description, the details are not given herein any further.

As shall be appreciated by those of ordinary skill in the art, the above discussion of any embodiments is only illustrative and is not intended to imply that the scope (including the claims) of the present disclosure is limited to these examples; and within the spirits of the present disclosure, technical features of the above embodiments or different embodiments may be combined with each other, the steps may be achieved in any sequence, and there are many other variations in different aspects of the present disclosure described above, although they are not detailed for purpose of simplicity.

Embodiments of the present disclosure are intended to cover all such replacements, modifications and variations falling within the broad scope of the attached claims. Accordingly, any omissions, modifications, equivalent replacements, and alterations within the spirits and principles of the present disclosure shall be included in the scope of the present disclosure.

What is claimed is:

1. A method for panoramic live broadcast, comprising:
at an electronic device;
continuously receiving collected pictures of live broadcast cameras at different viewpoints;
combining the collected pictures of the live broadcast cameras at different viewpoints in each frame into a panoramic picture;
receiving terminal posture change data;
performing analysis to obtain a terminal change angle according to the terminal posture change data;
performing calculation to obtain a new live picture viewpoint according to a viewpoint of a current live picture and the terminal change angle; and
selecting a picture corresponding to the new live picture viewpoint from the panoramic picture as a new live picture.

2. The method according to claim 1, wherein the live broadcast cameras at different viewpoints comprise a main live broadcast camera, after continuously receiving collected pictures of live broadcast cameras at different viewpoints, the method further comprises:
in an initial state, using a collected picture of the main live broadcast camera as an initial live picture.

3. The method according to claim 2, wherein after receiving terminal posture change data, the method further comprises:
determining whether the terminal posture change data within a preset time interval is between preset posture change data thresholds, wherein the preset posture change data thresholds are associated with an instruction of returning to the collected picture of the main live broadcast camera; and
switching from a current live picture to the collected picture of the main live broadcast camera if the terminal posture change data within the preset time interval is between the preset posture change data thresholds.

4. The method according to claim 1, wherein after combining the collected pictures of the live broadcast cameras at different viewpoints in each frame into a panoramic picture, the method further comprises:
receiving terminal touch gesture data;
determining whether the terminal touch gesture data is between preset touch gesture data thresholds, wherein the preset touch gesture data thresholds are associated with an instruction of scaling the live picture;
performing calculation to obtain a scaling ratio and a trigger location of the terminal touch gesture data according to the terminal touch gesture data if the terminal touch gesture data is between the preset touch gesture data thresholds; and
scaling the current live picture with the trigger location as a center according to the scaling ratio.

5. The method according to claim 1, wherein before receiving terminal posture change data, the method further comprises:
receiving an angle multiple change instruction; and
performing analysis to obtain an angle change multiple according to the terminal multiple change instruction.

6. The method according to claim 5, wherein performing analysis to obtain a terminal change angle according to the terminal posture change data comprises:
performing analysis to obtain an original change angle according to the terminal posture change data; and
performing calculation to obtain a terminal change angle, based on the angle change multiple and the original change angle.

7. An electronic device, comprising:
at least one processor; and
a memory communicably connected with the at least one processor for storing instructions executable by the at least one processor, wherein execution of the instructions by the at least one processor causes the at least one processor to:
continuously receive collected pictures of live broadcast cameras at different viewpoints;
combine the collected pictures of the live broadcast cameras at different viewpoints in each frame into a panoramic picture;
receive terminal posture change data;
perform analysis to obtain a terminal change angle according to the terminal posture change data;
perform calculation to obtain a new live picture viewpoint according to a viewpoint of a current live picture and the terminal change angle; and
select a picture corresponding to the new live picture viewpoint from the panoramic picture as a new live picture.

8. The electronic device according to claim 7, wherein the live broadcast cameras at different viewpoints comprise a main live broadcast camera, after continuously receiving collected pictures of live broadcast cameras at different viewpoints, execution of the instructions by the at least one processor further causes the at least one processor to:
in an initial state, use a collected picture of the main live broadcast camera as an initial live picture.

9. The electronic device according to claim 8, wherein after receiving terminal posture change data, execution of the instructions by the at least one processor further causes the at least one processor to:
determine whether the terminal posture change data within a preset time interval is between preset posture change data thresholds, wherein the preset posture change data thresholds are associated with an instruction of returning to the collected picture of the main live broadcast camera; and
switch from a current live picture to the collected picture of the main live broadcast camera if the terminal posture change data within the preset time interval is between the preset posture change data thresholds.

10. The electronic device according to claim 7, wherein after combining the collected pictures of the live broadcast cameras at different viewpoints in each frame into a panoramic picture, execution of the instructions by the at least one processor further causes the at least one processor to:
receive terminal touch gesture data;
determine whether the terminal touch gesture data is between preset touch gesture data thresholds, wherein the preset touch gesture data thresholds are associated with an instruction of scaling the live picture;
perform calculation to obtain a scaling ratio and a trigger location of the terminal touch gesture data according to the terminal touch gesture data if the terminal touch gesture data is between the preset touch gesture data thresholds; and
scale the current live picture with the trigger location as a center according to the scaling ratio.

11. The electronic device according to claim 7, wherein before receiving terminal posture change data, execution of the instructions by the at least one processor further causes the at least one processor to:
receive an angle multiple change instruction; and
perform analysis to obtain an angle change multiple according to the terminal multiple change instruction.

12. The electronic device according to claim 11, wherein performing analysis to obtain a terminal change angle according to the terminal posture change data comprises:
performing analysis to obtain an original change angle according to the terminal posture change data; and
performing calculation to obtain a terminal change angle, based on the angle change multiple and the original change angle.

13. A non-transitory computer-readable storage medium storing executable instructions, wherein when executed by an electronic device, causes the electronic device to:
continuously receive collected pictures of live broadcast cameras at different viewpoints;
combine the collected pictures of the live broadcast cameras at different viewpoints in each frame into a panoramic picture;
receive terminal posture change data;
perform analysis to obtain a terminal change angle according to the terminal posture change data;
perform calculation to obtain a new live picture viewpoint according to a viewpoint of a current live picture and the terminal change angle; and
select a picture corresponding to the new live picture viewpoint from the panoramic picture as a new live picture.

14. The non-transitory computer-readable storage medium according to claim 13, wherein the live broadcast cameras at different viewpoints comprise a main live broadcast camera, after continuously receiving collected pictures of live broadcast cameras at different viewpoints, the executable instructions is executed by the electronic device, further causes the electronic device to:
in an initial state, use a collected picture of the main live broadcast camera as an initial live picture.

15. The non-transitory computer-readable storage medium according to claim 14, wherein after receiving terminal posture change data, the executable instructions is executed by the electronic device, further causes the electronic device to:
determine whether the terminal posture change data within a preset time interval is between preset posture change data thresholds, wherein the preset posture change data thresholds are associated with an instruction of returning to the collected picture of the main live broadcast camera; and
switch from a current live picture to the collected picture of the main live broadcast camera if the terminal posture change data within the preset time interval is between the preset posture change data thresholds.

16. The non-transitory computer-readable storage medium according to claim 13, wherein after combining the collected pictures of the live broadcast cameras at different viewpoints in each frame into a panoramic picture, the executable instructions is executed by the electronic device, further causes the electronic device to:
receive terminal touch gesture data;
determine whether the terminal touch gesture data is between preset touch gesture data thresholds, wherein the preset touch gesture data thresholds are associated with an instruction of scaling the live picture;
perform calculation to obtain a scaling ratio and a trigger location of the terminal touch gesture data according to the terminal touch gesture data if the terminal touch gesture data is between the preset touch gesture data thresholds; and
scale the current live picture with the trigger location as a center according to the scaling ratio.

17. The non-transitory computer-readable storage medium according to claim 13, wherein before receiving terminal posture change data, the executable instructions is executed by the electronic device, further causes the electronic device to:
receive an angle multiple change instruction; and
perform analysis to obtain an angle change multiple according to the terminal multiple change instruction.

18. The non-transitory computer-readable storage medium according to claim 17, wherein performing analysis to obtain a terminal change angle according to the terminal posture change data comprises:
performing analysis to obtain an original change angle according to the terminal posture change data; and
performing calculation to obtain a terminal change angle, based on the angle change multiple and the original change angle.
